(19) United States
(12) Patent Application Publication
(10) Pub. No.: US 2015/0081438 A1
(43) Pub. Date: Mar. 19, 2015

(54) METHOD AND SYSTEM FOR TRACKING CONSUMER DIGITAL BODY LANGUAGE

(71) Applicant: Oracle International Corporation, Redwood Shores, CA (US)

(72) Inventors: Michael J. STRUTTON, Villa Rica, GA (US); Steven Keith WOODS, Etobicoke (CA); Chad ESTES, Atlanta, GA (US); Kimberly Ann WOLFE, Decatur, GA (US); Donald Chun Wing HO, Thornhill (CA); Yizhou JIANG, Belmont, CA (US); Natalie YOU, Mountain View, CA (US); Wenhua LI, Palo Alto, CA (US)

(73) Assignee: ORACLE INTERNATIONAL CORPORATION, Redwood Shores, CA (US)

(21) Appl. No.: 14/491,573

(22) Filed: Sep. 19, 2014

Related U.S. Application Data
(60) Provisional application No. 61/880,024, filed on Sep. 19, 2013.

(51) Int. Cl. G06Q 30/02; G06Q 50/00

(52) U.S. Cl. CPC G06Q 30/0255; G06Q 50/01
USPC 705/14.53

(57) ABSTRACT

The present application presents an improved approach for tracking consumer digital body language. A campaign is assigned to social posts by specifying one or more campaign tags and a tracking URL template. Posts associated with a campaign are created by entering post details and parameters and automatically retrieving the campaign tags. The parameters and template may be used to form a tracking URL to be published with the post. When a consumer clicks on a URL associated with a published post, the tracking URL is read and parsed, so that the tracking information may be read and stored for analysis. In addition, digital body language may be stored for the consumer. The consumer will then be redirected to the destination URL.

### CROSS-REFERENCE TO RELATED APPLICATIONS

The present application claims the benefit of priority to U.S. Provisional Application Ser. No. 61/880,024, filed on Sep. 19, 2013, which is hereby incorporated by reference in its entirety.

The present application is related to U.S. patent application Ser. No. 14/491,387, Attorney Docket No. ORA140353-US-NP, entitled “Method and System for Implementing Digital Link Tracking”, filed on even date herewith, and is hereby incorporated by reference in its entirety.

### COPYRIGHT NOTICE

A portion of the disclosure of this patent document contains material which is subject to copyright protection. The copyright owner has no objection to the facsimile reproduction by anyone of the patent document or the patent disclosure, as it appears in the Patent and Trademark Office patent file or records, but otherwise reserves all copyright rights whatsoever.

### BACKGROUND

The present application relates to software development and more specifically to systems and methods for implementing enterprise software applications.

The popularity of social media websites and portals, such as Facebook, Twitter, and others in recent years has provided marketers and advertisers with new avenues and opportunities for marketing their products and services. Social media sites provide a platform for individual consumers and marketers to communicate and interact, e.g., through Facebook pages or Twitter handles. Marketers can post messages or advertisements on these social media systems as a way to advertise outside traditional marketing channels. Consumers, in turn, can respond by clicking on embedded links, replying to the messages, share posts based on the messages, or performing other site-specific functions. Further, marketers can embed an organization-specific or marketing campaign-specific URLs (Webpage address) within the messages, driving users and Web traffic to a separate Web site.

The increased interactions between marketers and consumers over social media platforms may present many new opportunities for marketers. If marketers are able to track the behavior of consumer interactions with social media posts and URLs, it may allow for additional personalization of marketing and promotion. Consumer online behavior and interactions with digital marketing properties may be collectively referred to as a consumer's “digital body language.” For example, if a consumer is known by the marketer to have clicked on URLs corresponding to a particular marketing campaign a certain number of times, it may be desirable to be able to send them an email or special offer relating to the campaign. It may also be desirable to redirect consumers that have clicked on a URL to a different page, if they have demonstrated interest in a particular campaign, compared to consumers that clicked the URL who are being exposed to the campaign for the first time.

Current tracking URLs can be used by a tracking service to determine an amount of traffic or number of clicks to a land page coming from various sources. However, while tracking URLs may be useful for gathering aggregate data, they typically are not able to analyze the behavior of individual users. Tracking URLs are also passive, able to store aggregate information, but not actively influence how the consumer is to be marketed to. On the other hand, while typical methods for tracking user activity may be used to form a history or log of pages that a user has visited, they typically cannot determine how the user reaches those pages.

Therefore, there is a need for an improved approach for tracking consumer digital body language.

### SUMMARY

The present application presents an improved approach for tracking consumer digital body language. In some embodiments, a campaign originally created in marketing automation application (e.g., the Eloqua product, available from Oracle Corporation of Redwood Shores, Calif.) is assigned to social posts by specifying one or more campaign tags within an SRM (social relationship management) platform. The campaign may be associated with a tracking URL template for dynamically creating tracking URLs. Posts associated with a campaign may be created by entering post details and parameters and automatically retrieving the campaign tags. The parameters and template may be combined with a base URL specifying the tracking service to be used to form a tracking URL to be published with the post.

When a consumer clicks on a URL associated with a published post, the tracking URL is read and parsed by tracking and analytics services. Tracking information may be read by a tracking service and stored for analysis. In addition, digital body language may be stored for the consumer. In some embodiments, storing digital body language may comprise determining whether a consumer system contains a tracking cookie, and identifying a consumer profile containing past consumer behavior if a cookie is found. The consumer will then be redirected to the destination URL.

Further details of aspects, objects, and advantages of the invention are described below in the detailed description, drawings, and claims. Both the foregoing general description and the following detailed description are exemplary and explanatory, and are not intended to be limiting as to the scope of the invention.

### BRIEF DESCRIPTION OF THE FIGURES

The present invention is illustrated by way of example, and not by way of limitation, in the figures of the accompanying drawings and in which like reference numerals refer to similar elements and in which:

FIG. 1 illustrates an architecture of implementing tracking digital body language in accordance with some embodiments.

FIGS. 2A and 2B illustrate a system for implementing URL tracking and digital body language in accordance with some embodiments.

FIG. 3 illustrates an example tracking URL in accordance with some embodiments.

FIG. 4 illustrates a process for implementing URL tracking and digital body language in accordance with some embodiments.

FIG. 5 illustrates a flowchart of a process for creating an SRM post in accordance with some embodiments.

FIG. 6 illustrates a flowchart of a process for tracking and storing digital body language following a consumer click of a URL in accordance with some embodiments.

FIGS. 7A and 7B illustrate example database schemes that may be used in accordance with some embodiments.

FIG. 8 illustrates a computerized system on which an embodiment of the invention can be implemented.

### DETAILED DESCRIPTION

Embodiments of the invention provide an improved approach for tracking consumer digital body language. Various embodiments are described hereinafter with reference to the figures. It should be noted that the figures are not drawn to scale and that the elements of similar structures or functions are represented by like reference numerals throughout the figures. It should also be noted that the figures are only intended to facilitate the description of the embodiments. They are not intended as an exhaustive description of the invention or as a limitation on the scope of the invention. In addition, an illustrated embodiment need not have all the aspects or advantages shown. An aspect or an advantage described in conjunction with a particular embodiment is not necessarily limited to that embodiment and can be practiced in any other embodiments even if not so illustrated. Also, reference throughout this specification to “some embodiments” or “other embodiments” means that a particular feature, structure, material, or characteristic described in connection with the embodiments is included in at least one embodiment. Thus, the appearances of the phrase “in some embodiment” or “in other embodiments” in various places throughout this specification are not necessarily referring to the same embodiment or embodiments. In addition, for the purposes of illustration and explanation, the present disclosure is described in various embodiments in the context of SRM applications. It is noted, however, that the invention is not limited in its scope to SRM applications, and indeed, may be applied to other types of applications as well.

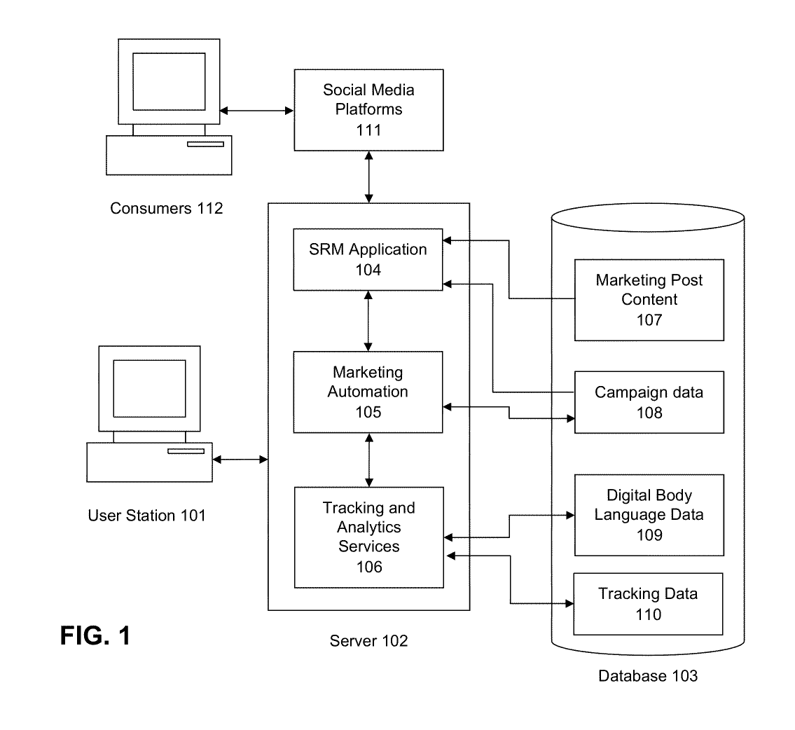

FIG. 1 shows an architecture of a system 100 according to some embodiments. The users (e.g., marketers) operate the system at a user station 101 to access and utilize applications on an application server 102, such as an SRM application 104, marketing automation application 105, and tracking and analytics services 106. Applications and services on server 102 may access data on database 103, which may include marketing post data 107, campaign data 108, tracking information 109, and consumer digital body language information 110. As described in more detail below, the users at user station 101 may use SRM application 104 to create and/or manage posts and messages for various social media sites or platforms. In some embodiments, the posts or messages are created using data from marketing post data 107, which may contain graphics or videos to be displayed, standardized text, post templates, or other types of content that may be used in creating a post or message.

SRM posts and messages created with SRM application 104 are often associated with campaigns or promotions. In some embodiments, parameters for campaigns may be specified using marketing automation application 105 and stored as campaign data 108. When a user specifies a campaign when creating a post using SRM application 104, parameters associated with the campaign may be automatically retrieved from campaign data 108 through marketing automation application 105. In addition, marketing automation application 105 may be used in some embodiments to designate landing pages and base URLs to be associated with the posts, which is explained in further detail below.

Some posts may contain a URL that, when clicked on by a consumer, takes the consumer to another webpage, such as a page describing a marketing campaign or promotion. In order to be able to track consumer behavior, the URL may be a tracking URL with one or more tracking parameters. In some embodiments, tracking URLs may be dynamically generated using a tracking URL template. An example system and method for creating tracking link templates for dynamically generating tracking URLs is described in U.S. patent application Ser. No. 14/491,387, “Method and System for Implementing Dynamic Link Tracking”, attorney docket number ORA140353-US-NP, which is hereby incorporated by reference in its entirety. In some embodiments, tracking and analytics services 106 are used to define tracking URL templates that are able to be used with the services.

Posts created by a user at user station 101 using SRM Application 104 are published to one or more social media platforms 111, where they may be viewed by consumers 112. In additions to social media sites, posts may also be published to an email or a mailing list, or to a non-social media site (not shown). When a consumer 112 clicks on a tracking URL included with a post, tracking and analytics services 106 are used to track consumer clicks and consumer behavior, as well as redirect the consumer to the desired destination URL or landing page.

Tracking and analytics services 106 may take tracking data 110 and digital body language data 109 in response to consumer behavior. Tracking data 110 typically keeps track of consumer URL clicks, and may be used by a marketer for analyzing consumer response to a post. For example, tracking data 110 may be used to determine how many consumers clicked a URL for a given post in a given time period, how many consumers clicked URLs associated with a certain campaign, through which channels/social media platforms the clicks originated from, how many orders resulted from the clicks, etc.

Digital body language data 109 typically tracks the behavior of individual consumers (e.g., a consumer's history of interactions with a marketer or marketing campaign). For example, digital body language data for a particular consumer may reflect whether the consumer has clicked any URLs relating to a particular campaign in the past, through what channels the consumer has interacted with the campaign, whether the consumer has ordered a product or service associated with the marketer, etc. This information may be used for lead scoring or performing more personalized actions for certain groups of consumers (e.g., sending a message about an upcoming promotion to consumers who have expressed interest in a particular campaign or interacted with the campaign in a particular way).

In system 100, user station 101 comprises any type of computing station that may be used to operate or interface with a server 102. Examples of such user stations 101 include for example, workstations, personal computers, laptop computers, or remote computing terminals. User station 101 may also comprise any type of portable tablet device, including for example, tablet computers, portable readers, etc., or mobile device that can suitably access an application on application server 102, such as smartphones and programmable mobile handsets. User station 101 usually includes a display device, such as a display monitor or screen, for displaying scheduling data and interface elements to users. User station 101 may also comprise one or more input devices for the user to provide operational control over the activities of system 100, such as a mouse, touch screen, keypad, or keyboard. The users may correspond to any individual, organization, or other entity that uses system 100 to remotely access applications on application server 102, such as an SRM application, a marketing automation application, and/or tracking and analytics services on application server 102.

The database 103 may correspond to any type of computer readable mediums or storage devices. The computer readable storage devices comprise any combination of hardware and software that allows for ready access to the data within the database. For example, the computer readable storage device could be implemented as computer memory or disk drives operatively managed by an operating system.

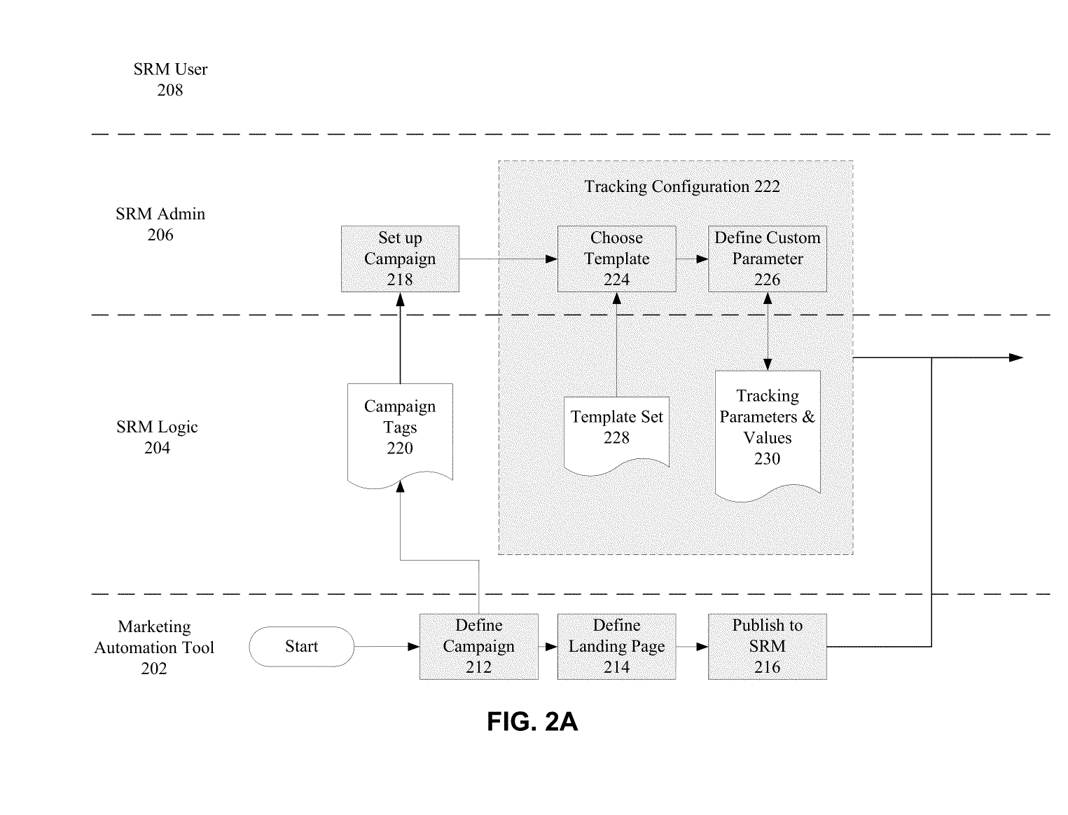

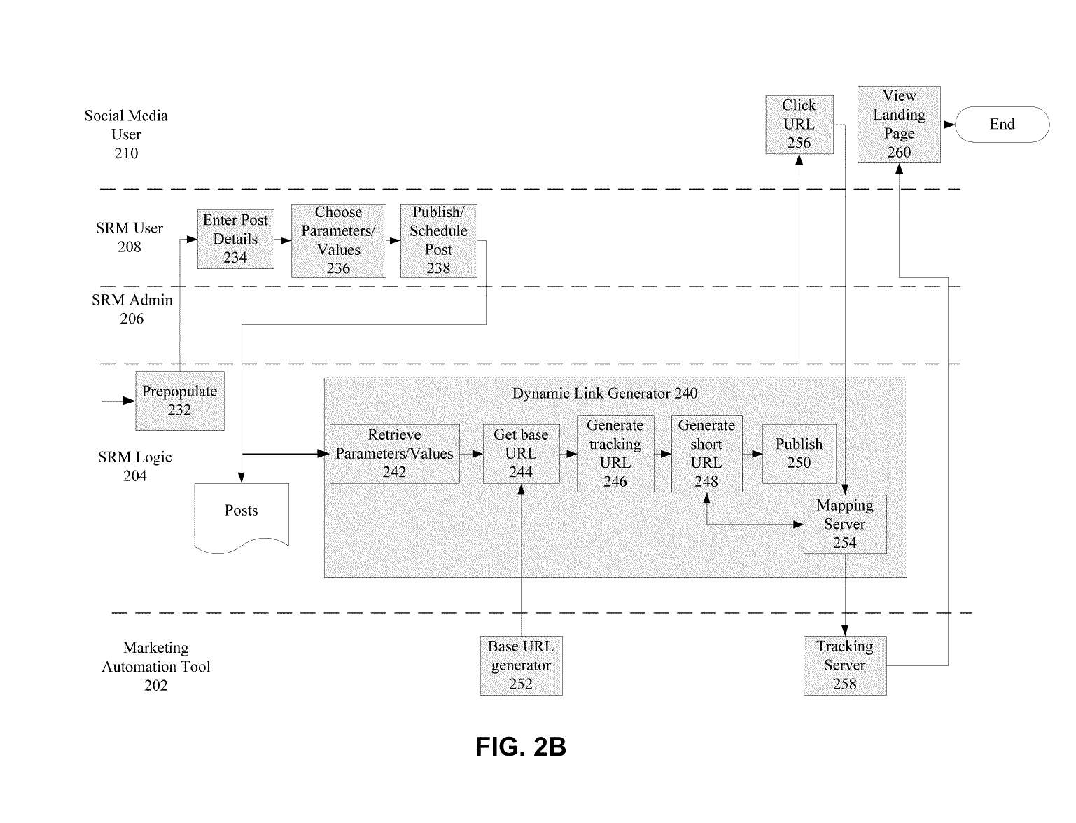

FIGS. 2A and 2B illustrate a system for implementing URL tracking and digital body language in accordance with some embodiments. In the illustrated embodiment, SRM administrators 206 and SRM users 208 operate on SRM logic 204 and marketing automation program 202 to define campaigns and publish social media posts and messages, which are then viewed by social media users or consumers 210. While the illustrated embodiment shows SRM administrators 206 as responsible for setting up and defining a campaign, while SRM users 208 create the social media posts and messages associated with the campaign, it is understood that in other embodiments, other roles and configurations may be possible (e.g., an SRM administrator may both set up a campaign and create posts for the campaign). In addition, while the figures refer primarily to social media posts, the techniques disclosed herein may also be applied to other types of posts, e.g., posts sent through email, or posted on sites that are not social media sites.

As most SRM posts are associated with a campaign or promotion, before creating an SRM post, a campaign must be typically be set up first. In some embodiments, parameters for the campaign, such as campaign name, term, description, etc. may be defined using marketing automation tool 202 at 212. Defining a campaign may comprise creating or specifying one or more campaign IDs and/or campaign tags, such as a campaign ID number, campaign name, term, description, and/or other properties associated with the campaign. These campaign IDs and tags may be automatically mapped and stored at the SRM application level to set up the campaign at the SRM application through a campaign setup API. For example, as illustrated in FIG. 2A, once a campaign has been defined at 212, an SRM administrator 206 may use campaign tags 220 to set up the campaign at 218 at the SRM application for which the SRM posts will be associated with.

Following campaign definition, the marketing automation application 202 may, in some embodiments, also be used to define one or more landing pages 214, i.e. pages to be reached by clicking on a URL in an SRM post. In some embodiments, SRM posts may also use landing pages other than those defined using the marketing automation application 202 at 214.

At 222, the campaign is associated with one or more tracking URL templates, which are used to create tracking URLs for SRM posts. Because different tracking services (e.g., Google Analytics, Eloqua, etc.) may recognize different parameter formats, a tracking URL template is chosen at 224 that is compatible with the tracking service being used. The template may be created by the SRM administrator, or selected from a set of existing templates 228.

A tracking URL template may define a plurality of post parameters relating to a post that the URL is associated with, such as a post ID, social media site the post was posted on, campaign the post is associated with, time stamp of post, etc. In addition to standard post parameters, the tracking URL template may also contain one or more custom parameters and values, which may be defined at 226. Custom parameters may include parameters useful for tracking analysis but are not part of the content of the actual posts. These may include campaign details, landing page type, content style, post objective, a user memo, etc. In some embodiments, the custom parameters correspond with the campaign tags 220 defined by the SRM administrator 206 when setting up the campaign. In addition, in some embodiments custom parameters not associated with campaign tags 220 may also be specified.

Once the tags, tracking template, and custom parameters for the campaign have been defined, the campaign may be published to the SRM at 216 so that SRM users 208 are able to create posts and messages associated with the campaign.

The SRM application is used by an SRM user 208 to create a post. When post creation is initialized, campaign tags and destination URLs corresponding to landing pages may be retrieved automatically at 232 from the marketing automation application 202 and pre-populated into the post creation interface. The SRM user may then enter additional post details, such as post text, as well as pictures, videos, or other media content at 234. A destination URL for a landing page may also be specified if one was not pre-populated from the marketing automation application 202. In some embodiments, an SRM user may also choose to override any pre-populated values with new values.

The SRM user 208 may also choose values for one or more custom parameters to be included in a tracking URL at 236. In some embodiments, some of the custom parameters, such as campaign tags, may have already been pre-populated. The post may then be saved and scheduled for publishing at 238.

When publishing a post containing a URL, a tracking URL is dynamically generated to be included in the post by a dynamic link generator 240. First, post parameters and custom parameter values are retrieved from the post at 242, and formatted in accordance with the tracking URL template corresponding to the campaign. In some embodiments, post parameters (e.g., stream to be published to, post ID, time stamp, etc.) are automatically determined from the post details, while custom parameters are determined from the user inputs or pre-populated fields.

In some embodiments, the dynamic link generator 240 may retrieve a base URL from a base URL generator 252 in the marketing automation application 202. In some embodiments, the base URL corresponds to the tracking service to be used. The base URL is combined with the tracking URL template and retrieved parameters to form a complete tracking URL at 246.

In some embodiments, a short URL is generated from the tracking URL at 248. A short URL may be used in some cases to satisfy social media character limits, or to create a more aesthetically pleasing and more compact URL to be displayed. The short URL may be generated using a URL mapping server 525, which may also store a mapping between the tracking URL and the generated short URL. The short URL is then published with the post at 250.

When a consumer or social media user 210 views a published post and selects the short URL associated with the post at 256, the URL mapping server 254 is used to retrieve the full tracking URL that is mapped to the short URL. The tracking URL is passed to a tracking server 258, where the parameters of the tracking URL may be parsed and analyzed. This may be used to form aggregated data relating to the campaign or social media post (e.g., how many social media users clicked on a URL associated with the campaign, through which channels/social media platforms did the clicks originate from, etc.). In addition, tracking server 258 attempts to identify the social media user 210, in order to form a digital body language profile for the user, recording the interactions of individual users with the campaign. For example, the digital body language profile of the user may comprise from which channels the user clicked from, the landing pages visited by the user, the context from which the landing pages were visited from, and the campaigns associated with the visited landing pages.

The tracking server also identifies a destination URL (e.g., a URL of the landing page), and redirects the consumer to the corresponding landing page, allowing the consumer 210 to view the landing page at 260. In some embodiments, the tracking server may, based upon the digital body language of the consumer, redirect the consumer to a landing page containing different content (e.g., a different landing page, or an altered or customized landing page). For example, consumers who clicked from a first social media channel may be redirected to a landing page containing different content as consumers who clicked from a second social media channel. In addition, the consumers from the first social media channel may be associated with a particular marketing workflow path, where they are targeted with different types of marketing compared to the consumers from the second social media channel. It is understood that other factors may also be used in considering which landing page to direct the consumer and/or determining a marketing workflow path flow for the consumer, such as the identity of the consumer, whether or not the consumer has interacted with the campaign before, other campaigns the consumer has interacted with, whether the consumer has purchased a product or service, preference settings by the consumer, consumer location, etc.

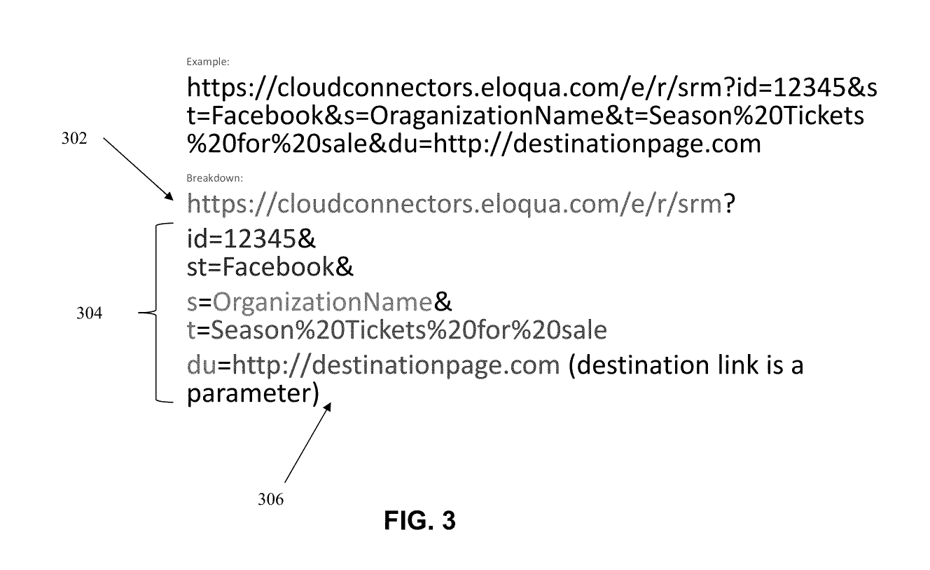

FIG. 3 illustrates an example tracking URL in accordance with some embodiments, comprising a base URL 302 and a query string 304. In some embodiments, the base URL 302 points to a URL for the tracking service (e.g., Eloqua). The query string 304 is appended to the base URL 302 may contain various tracking parameters such as post ID, social media platform published on, post source, promotion, etc. The destination URL 306 corresponding to a landing page is also specified as part of the parameters of query string 304. When parsing the wrapped URL, the tracking service extracts the destination URL 306 from query string 304, and redirects the consumer to the landing page corresponding to the destination URL 306. It is understood that although the figure illustrates a particular tracking URL format, other types of tracking URL formats may be used depending the tracking service and/or selected template.

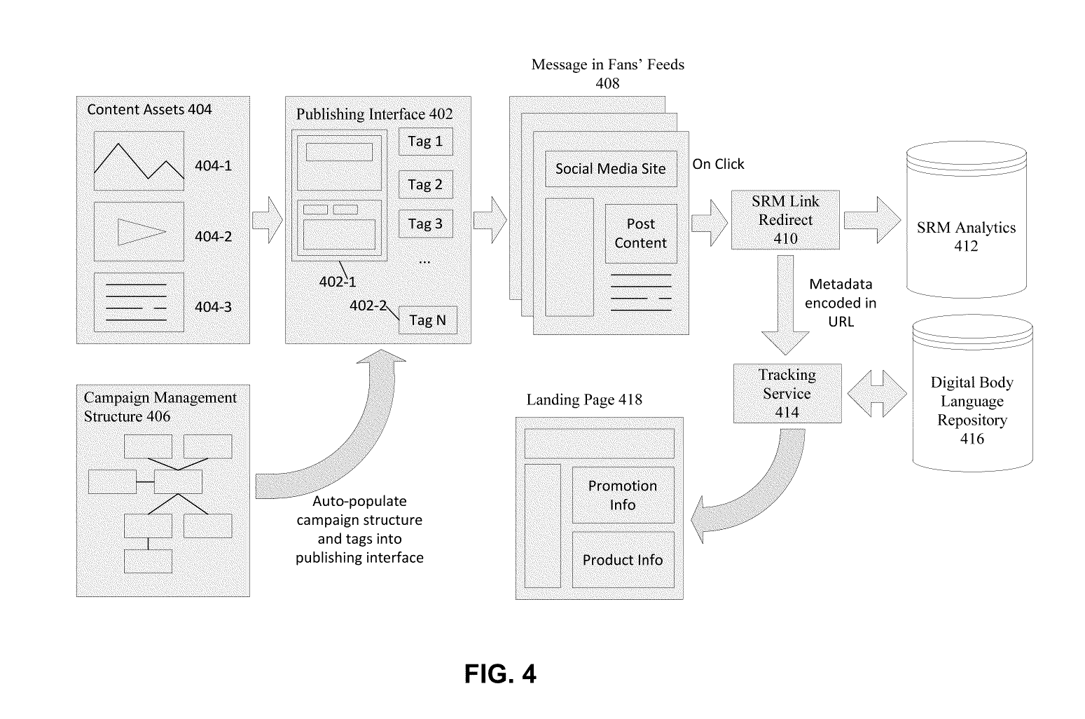

FIG. 4 illustrates a process for implementing URL tracking and digital body language in accordance with some embodiments. As illustrated in the figure, a user may use a UI 402-1 at a publishing interface 402 to create a post or social media message. Publishing interface 402 may be used to retrieve content assets 404 (e.g., pictures 404-1, videos 404-2, or text 404-3) to include as part of the post or message. In addition, publishing interface 402 may be used to retrieve a tracking template and one or more tags 402-2, wherein the template and tags correspond to a campaign structure generated by marketing automation application 406. Thus, posts created using publishing interface 402 can be associated with particular a campaign or promotion. The retrieved campaign tags 402-2 may include campaign name, ID, description, and/or other campaign properties. In addition to tags retrieved from marketing automation application 406, the user may also choose to define one or more custom parameters to be associated with the post. These tags and parameters may then be used with the retrieved template to construct a tracking URL.

The retrieved content and tags are combined with user-inputted data at UI 402-1 to form a published post or message 408 one or more social media platforms (e.g., Facebook, Twitter, etc.). For example, a post may be published to a marketer's Facebook page, which then shows up in the feeds of consumers who are fans of the page. Alternatively, the post may be sent to consumers on a mailing list, or be viewed by consumers on other types of sites (e.g., an online bulletin or forum, the marketer's own web page, etc.).

When a consumer clicks on a URL in a published post or message 408, the URL is received by a link redirect server 410. The link redirect server may parse the URL and pass tracking parameters extracted from the URL to an analytics service 412, which uses the received parameters to analyze consumer clicks of the URL. For example, the analytics service 412 may be used be determine the number of consumer clicks on a particular post, or on posts associated with a particular campaign. Additional parameters from the tracking URL may be used to provide analysis (e.g., compare clicks originating from a Facebook post to clicks from a Twitter post).

The URL may also be passed to a tracking service/digital body language server 414. Digital body language server 414 attempts to identify the consumer and any existing body language data associated with the consumer. In some embodiments, the digital body language server 414 attempts to identify the consumer by determining if the consumer has a tracking cookie. If there is no cookie, a cookie may be dropped on the consumer's system, allowing for the consumer to be identified in the future. If a cookie already exists, it is matched with consumer information in a digital body language repository 416. The new tracking information for the consumer resulting from the URL click is stored in the repository and associated with any existing information regarding the consumer. The digital body language server 414 then redirects the consumer to the landing destination page.

It is understood that in other embodiments, other techniques or combinations of techniques may be used to track or identify a particular consumer. For example, in some embodiments, consumers may also be tracked by identifying an account they are logged into when clicking the URL (e.g., a Google account, a Facebook account, an email account, etc.).

The consumer information stored in the digital body language repository 416 provides a record of the consumer's past digital interactions with the marketer. For example, if the consumer has clicked on other posts published by the marketer in the past, this may be reflected in the consumer's digital body language. In addition, if the consumer fills out a form, places an order, or otherwise interacts with the landing page, the consumer's actions may also be recorded. The repository 416 may also store consumer contact information or other information that has been provided by the consumer (e.g., through filling out a form).

By analyzing digital body language in conjunction with tracking URLs, the digital body language repository 416 is able to not only determine what pages a consumer has visited, but also how the consumer reached those pages. For example, in addition to being able to know that a consumer has reached a particular landing page, it can also be determined through which social media channel (e.g., Facebook, Twitter) the consumer reached the landing page, as well as the context from which the page was reached (as defined by the parameters of the tracking URL).

Furthermore, digital body language allows for behavior of consumers beyond individual clicks to be tracked. For example, if a consumer clicks on a tracking URL but does not purchase a product, but instead purchases a product at a later time, this may be reflected in the consumer's digital body language. The stored digital body language profiles may also be later used for further analysis and reporting. Because the digital body language data is associated with consumers on an individual level, more detailed data on consumer behavior can be obtained. For example, it may be determined through analysis that consumers who have interacted with a campaign in a particular way may be more likely to buy particular products at a later date, or be more receptive to particular types of marketing.

Thus, the consumer's digital body language provides a marketer with valuable information on the consumer, such as how they can be contacted, and which products, campaigns, or promotions they have been interested in the past. This may be used by the marketer for lead scoring purposes, or to personalize marketing actions toward the consumer. For example, the marketer may wish to send a message to consumers who have demonstrated interest in a past campaign, informing them of a new promotion. The message may further be customized depending upon in what manner the interest was expressed. A marketer may also wish to display different content on a landing page depending on whether a consumer is known to have been exposed to a particular campaign before or not (e.g., has the consumer clicked on a URL associated with the campaign before?). For example, a landing page may display “Welcome back!” if the consumer is known to have clicked on a URL associated with the campaign before. In some embodiments, the consumer may be redirected to different landing pages based upon other aspects of their digital body language information (e.g., the identity of the consumer, or the social media channel used that the consumer clicked from). Thus digital body language can be used by marketers to shape their understanding of and future interactions with individual consumers.

The tracking and digital body language services operate behind the scenes, such that when the consumer clicks the URL, they are redirected to the landing destination page 418 without knowledge of the tracking and digital body language functions that operate in the background.

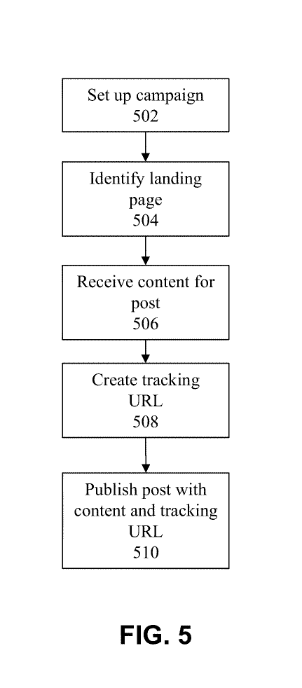

FIG. 5 illustrates a flowchart of a process for creating an SRM post in accordance with some embodiments. At 502, the user sets up a campaign. This may comprise specifying various campaign tags and parameters, such as campaign name, ID, term, description, etc. In addition, a tracking URL template may be associated with the campaign. At 504, one more landing pages associated with the campaign may be defined, which correspond to destination pages that a consumer reaches after clicking on a URL in a published post associated with the campaign.

At 506, content for a post may be received. This may include user-specified content to be displayed (e.g., text, pictures, etc.), a tracking URL template to be used to generate a tracking URL, and user-specified custom parameters. In some embodiments, some of the parameters to be associated with the post may be pre-populated. For example, if the post is associated with a particular campaign, the various campaign tags created during campaign setup may be received automatically.

At 508, a tracking URL is created from the post parameters and custom parameters specified by the post content. The received parameters are used to populate a tracking URL template. In some embodiments, a base URL may be received that corresponds to the tracking service to be used. The base URL and formatted parameters are combined to generate the tracking URL. In some embodiments, the tracking URL may be mapped to a short URL for publishing. At 510, the post, comprising post content and URL, are published to one or more social media sites.

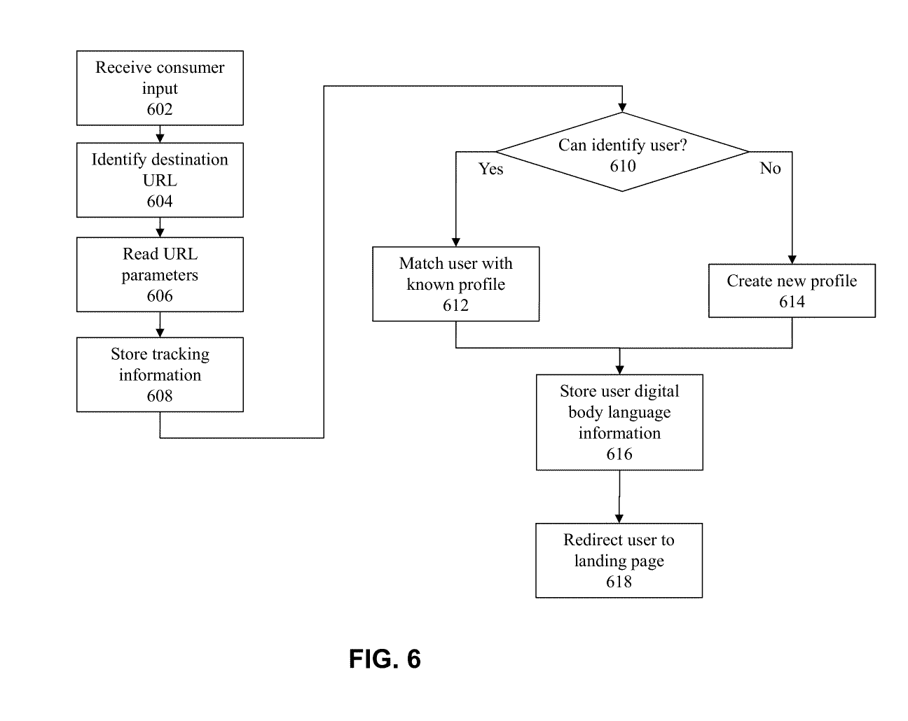

FIG. 6 illustrates a flowchart of a process for tracking and storing digital body language following a consumer click of a URL in accordance with some embodiments. At 602, an input from a consumer is received (e.g., a URL click). In some embodiments, the URL clicked is a short URL, in which case short URL to tracking URL mappings are used to determine the full tracking URL.

At 604, the tracking URL is parsed to identify a destination URL. In some embodiments, such as illustrated in FIG. 3, the destination URL is given as a parameter appended to a base URL, while in other embodiments the destination URL may correspond to the base URL. At 606, post parameters and/or custom parameters are read from the parsed tracking URL.

At 608, the identified parameters may be read by a tracking service for analysis. Tracking services may be used to track the number of clicks for particular posts or campaigns, to allow the marketer to assess the success of posts and campaigns by being able to view the clicks for a particular post or campaign. In some embodiments, tracking services may also be able to keep track of orders resulting from URL clicks. The identified parameters may be used by the marketer to further analyze and organize the information.

At 610, the tracking URL may be sent to a digital body language service, which attempts to identify the consumer and associate them with a digital body language profile, if one exists. In some embodiments, a determination is made as to if a tracking cookie is already present on the consumer system. If the consumer is identified (e.g., a tracking cookie already exists), the consumer is matched to a known profile at 612. The profile contains previous activities by the consumer. For example, if the consumer has clicked other URLs in posts made by the marketer, these may be reflected in the profile. Consumer actions on landing pages may also be recorded (e.g., if the consumer fills out a form or places an order). The profiles may also contain consumer information (e.g., consumer contact information received through a form or order). On the other hand, if the consumer is not matched with a known profile (e.g., a cookie is not found), a new profile may be created for the consumer at 612. In addition, a tracking cookie may be dropped on the consumer system so that the consumer may be identified in the future.

At 616, new digital body language information for the consumer may be stored and associated with the consumer profile, or used to create a new consumer profile if none currently exists. The stored digital body language profile for the user can be used by the marketer to analyze the behavior of individual consumers and determine future interactions with the consumer.

At 618, the consumer is redirected to the destination page. In some embodiments, the destination page may be changed or modified depending upon information retrieved from an existing consumer digital body language profile (e.g., redirecting a consumer to a different destination page if they have clicked on URLs relating to the campaign in the past). The destination page may also be changed or modified based upon received tracking URL parameters (e.g., channel), or a combination thereof.

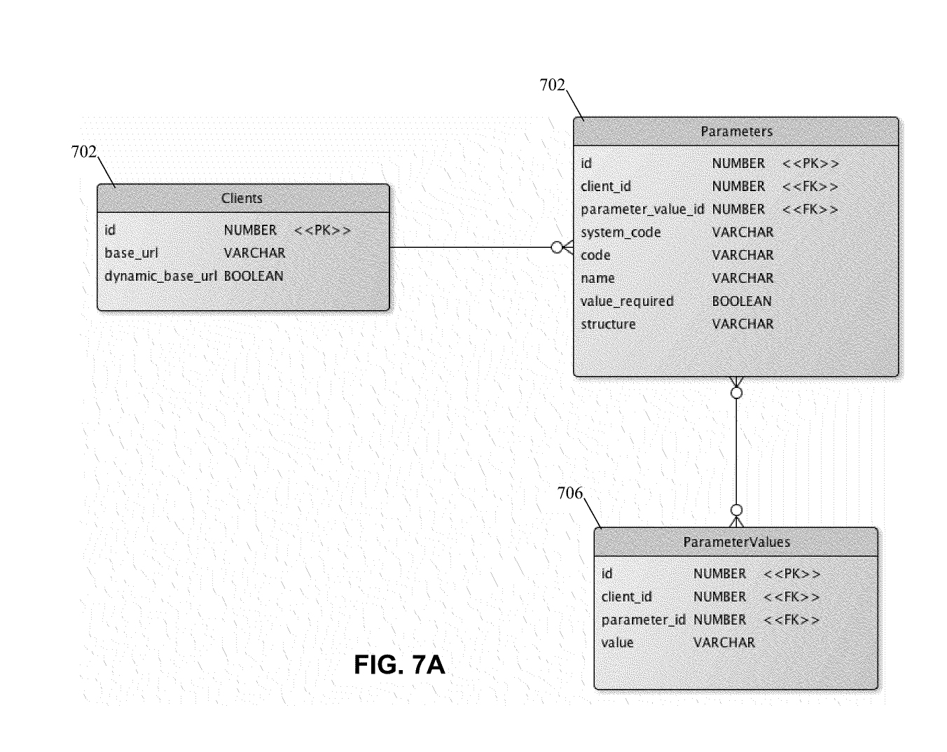

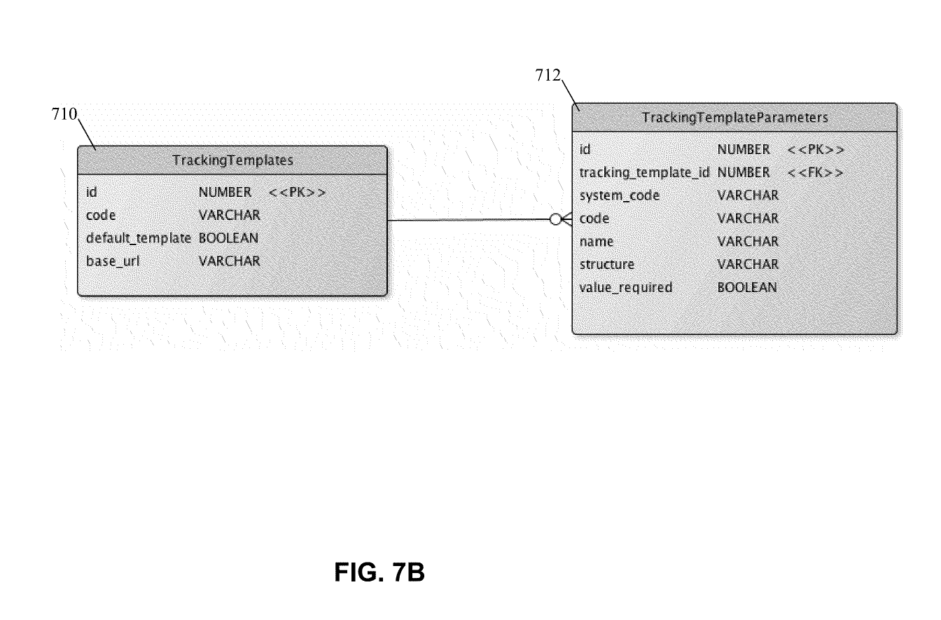

FIGS. 7A and 7B illustrate example database schemes that may be used in accordance with some embodiments. These schemes may be used to create tables to store marketer profiles and tracking link templates, store default parameters/values associated with each template, and store user-specified parameters/values. FIG. 7A illustrates an example scheme that may be used to store a profile for a marketer or other entity that may wish to use tracking templates or digital body language tracking. For example, each marketer, or “client” 702, may have an ID and a base URL associated with a tracking service. For example, different base URLs may correspond to different tracking services. In addition, a particular tracking service may be associated with multiple base URLs, and assign marketers to different base URLs based upon marketer size, location, tracking needs, or any other relevant criteria. Each marketer may also be associated with a plurality of parameters 704 corresponding to marketer information (e.g., name, address, contact information) and associated with one or more parameter values 706.

FIG. 7B illustrates an example scheme that may be used to store tracking URL templates. For example, each tracking URL template 710 may have an ID and code used to identify the template, a base URL associated with a tracking service, and an indication of whether the template is a default template. Each template 710 may be associated with one or more template parameters 712, which may include post parameters or custom user-defined parameters. Template parameters 712 may have different types of data structures and formats (e.g., text, numbers, etc.) and may be either mandatory parameters or optional parameters.

### System Architecture Overview

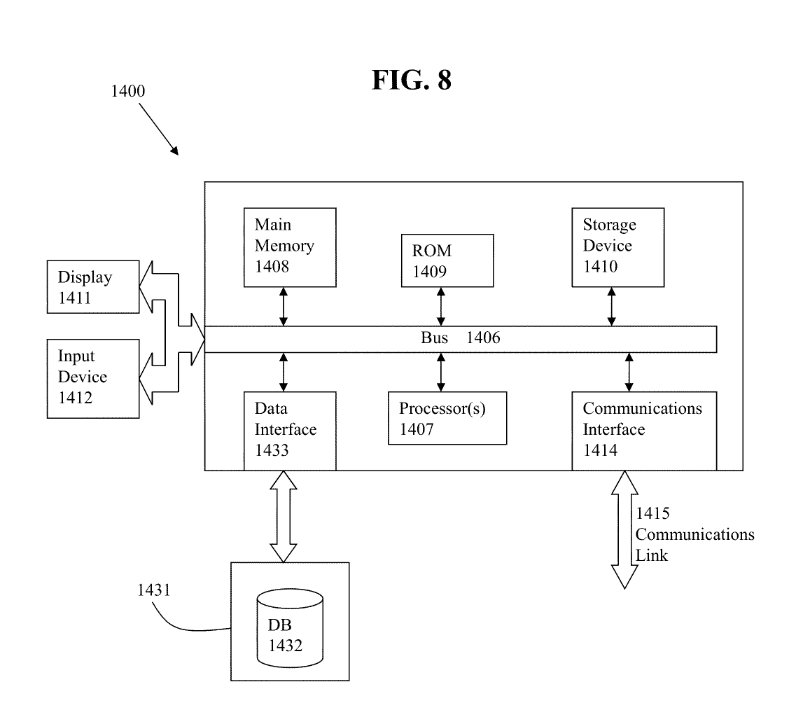

FIG. 8 is a block diagram of an illustrative computing system 1400 suitable for implementing an embodiment of the present invention. Computer system 1400 includes a bus 1406 or other communication mechanism for communicating information, which interconnects subsystems and devices, such as processor 1407, system memory 1408 (e.g., RAM), static storage device 1409 (e.g., ROM), disk drive 1410 (e.g., magnetic or optical), communication interface 1414 (e.g., modem or Ethernet card), display 1411 (e.g., CRT or LCD), input device 1412 (e.g., keyboard), and cursor control.

According to one embodiment of the invention, computer system 1400 performs specific operations by processor 1407 executing one or more sequences of one or more instructions contained in system memory 1408. Such instructions may be read into system memory 1408 from another computer readable/usable medium, such as static storage device 1409 or disk drive 1410. In alternative embodiments, hard-wired circuitry may be used in place of or in combination with software instructions to implement the invention. Thus, embodiments of the invention are not limited to any specific combination of hardware circuitry and/or software. In one embodiment, the term “logic” shall mean any combination of software or hardware that is used to implement all or part of the invention.

The term “computer readable medium” or “computer usable medium” as used herein refers to any medium that participates in providing instructions to processor 1407 for execution. Such a medium may take many forms, including but not limited to, non-volatile media and volatile media. Non-volatile media includes, for example, optical or magnetic disks, such as disk drive 1410. Volatile media includes dynamic memory, such as system memory 1408.

Common forms of computer readable media includes, for example, floppy disk, flexible disk, hard disk, magnetic tape, any other magnetic medium, CD-ROM, any other optical medium, punch cards, paper tape, any other physical medium with patterns of holes, RAM, PROM, EPROM, FLASH-EPROM, any other memory chip or cartridge, or any other medium from which a computer can read.

In an embodiment of the invention, execution of the sequences of instructions to practice the invention is performed by a single computer system 1400. According to other embodiments of the invention, two or more computer systems 1400 coupled by communication link 1415 (e.g., LAN, PTSN, or wireless network) may perform the sequence of instructions required to practice the invention in coordination with one another.

Computer system 1400 may transmit and receive messages, data, and instructions, including program, i.e., application code, through communication link 1415 and communication interface 1414. Received program code may be executed by processor 1407 as it is received, and/or stored in disk drive 1410, or other non-volatile storage for later execution. Data may be stored in a database 1432 on a storage medium 1431 which is accessed through data interface 1433.

In the foregoing specification, the invention has been described with reference to specific embodiments thereof. It will, however, be evident that various modifications and changes may be made thereto without departing from the broader spirit and scope of the invention. For example, the above-described process flows are described with reference to a particular ordering of process actions. However, the ordering of many of the described process actions may be changed without affecting the scope or operation of the invention. The specification and drawings are, accordingly, to be regarded in an illustrative rather than restrictive sense.

What is claimed is:

1. A method implemented with a processor, comprising:
using a computer, defining a marketing campaign, wherein the marketing campaign is associated with a plurality of campaign parameters;
publishing a post associated with the marketing campaign, wherein the post is associated with a tracking URL containing one or more of the plurality of campaign parameters; and
in response to receiving a selection of the tracking URL from a user;
processing the tracking URL using a tracking service; and
updating a user profile associated with the user based at least in part upon the tracking URL, wherein the user profile is stored in a profile repository and records an interaction history between the user and the marketing campaign;
identifying a destination page, based at least in part upon the tracking URL and the user profile; and
redirecting the user to the destination page.

2. The method of claim 1, wherein the social media post contains a shortened URL mapped to the tracking URL.

3. The method of claim 1, wherein processing the tracking URL comprises storing the parameters associated with the tracking URL to determine click traffic.

4. The method of claim 1, wherein updating a digital body language profile comprises determining whether the user matches an existing user profile.

5. The method of claim 1, wherein updating a user profile is based at least in part upon one or more of the parameters associated with the tracking URL.

6. The method of claim 4, further comprising creating a new user profile if no matching user profile is found.

7. The method of claim 6, wherein determining whether the user matches an existing user profile comprises determining whether or not there is a tracking cookie on a user system.

8. A computer readable medium having stored thereon a sequence of instructions which, when executed by a processor causes the processor to execute a method comprising:
using a computer, defining a marketing campaign, wherein the marketing campaign is associated with a plurality of campaign parameters;
publishing a post associated with the marketing campaign, wherein the post is associated with a tracking URL containing one or more of the plurality of campaign parameters; and
in response to receiving a selection of the tracking URL from a user;
processing the tracking URL using a tracking service; and
updating a user profile associated with the user based at least in part upon the tracking URL, wherein the user profile is stored in a profile repository and records an interaction history between the user and the marketing campaign;
identifying a destination page, based at least in part upon the tracking URL and the user profile; and
redirecting the user to the destination page.

9. The computer readable medium of claim 8, wherein the social media post contains a shortened URL mapped to the tracking URL.

10. The computer readable medium of claim 8, wherein processing the tracking URL comprises storing the parameters associated with the tracking URL to determine click traffic.

11. The computer readable medium of claim 8, wherein updating a digital body language profile comprises determining whether the consumer matches an existing digital body language profile.

12. The computer readable medium of claim 8, wherein updating a digital body language profile is based at least in part upon one or more of the parameters associated with the tracking URL.

13. The computer readable medium of claim 10, further comprising creating a new digital body language profile if no matching digital body language profile is found.

14. The computer readable medium of claim 13, wherein determining whether the consumer matches an existing digital body language profile comprises determining whether or not there is a tracking cookie on a consumer system.

15. A system, comprising:
a processor;
a memory comprising computer code executed using the processor, in which the computer code implements:
using a computer, defining a marketing campaign, wherein the marketing campaign is associated with a plurality of campaign parameters;
publishing a post associated with the marketing campaign, wherein the post is associated with a tracking URL containing one or more of the plurality of campaign parameters; and
in response to receiving a selection of the tracking URL from a user;
processing the tracking URL using a tracking service; and
updating a user profile associated with the user based at least in part upon the tracking URL, wherein the user profile is stored in a profile repository and records an interaction history between the user and the marketing campaign;
identifying a destination page, based at least in part upon the tracking URL and the user profile; and
redirecting the user to the destination page.

16. The system of claim 15, wherein the social media post contains a shortened URL mapped to the tracking URL.

17. The system of claim 15, wherein processing the tracking URL comprises storing the parameters associated with the tracking URL to determine click traffic.

18. The system of claim 15, wherein updating a digital body language profile comprises determining whether the consumer matches an existing digital body language profile.

19. The system of claim 15, wherein updating a digital body language profile is based at least in part upon one or more of the parameters associated with the tracking URL.

20. The system of claim 18, further comprising creating a new digital body language profile if no matching digital body language profile is found.
